(19) United States
(12) Patent Application Publication
(10) Pub. No.: US 2013/0086511 A1
(43) Pub. Date: Apr. 4, 2013

(54) DISPLAYING PLURALITY OF CONTENT ITEMS IN WINDOW

(71) Applicant: Scott PARSONS, San Francisco, CA (US)

(72) Inventor: Scott PARSONS, San Francisco, CA (US)

(73) Assignee: CBS Interactive, Inc.

(21) Appl. No.: 13/458,959

(22) Filed: Apr. 27, 2012

Related U.S. Application Data
(63) Continuation of application No. 13/251,095, filed on Sep. 30, 2011.

(51) Int. Cl. G06F 3/048

(52) U.S. Cl. 715/784; 715/781

(57) ABSTRACT

A web server computer comprises a memory configured to store a plurality of content items, each content item having tags representing the subject matter of the content items. A processing circuit is configured to receive a request from a user for a resource locator associated with a first content item, transmit the first content item to the user for display in a window containing the first content item, identify at least one tag associated with the first content item, search the database using the at least one tag to identify a second content item, and transmit the second content item to the user for display within the same window as the first content item.

### BACKGROUND OF THE INVENTION

The Internet provides web content of various types for use. In the case of a product information web site, the web site may include product reviews, images, videos, specifications, comparisons with other products, user commentary, locations where products may be purchased, prices for products, etc. In the case of a news web site, the web site may include news articles, photographs, user commentary, URL web links to related articles, etc. In the case of a blog web site, the web site may include blog entries, categories of blog entries, links to related or suggested blogs, reader comments, etc.

Visitors often come to a web site from a referring web site or web search page. The visitors view the content, then they usually leave after they look at that piece of content. If they want to find additional content on the web site, they must hunt for it through many options for additional viewing, such as links, additional searches, and other web page elements.

### BRIEF DESCRIPTION OF THE DRAWINGS

FIG. 1 is a schematic diagram of a display of related content items, according to an exemplary embodiment.

FIG. 2 is a block diagram of a computer system configured to implement the functions described herein, according to an exemplary embodiment.

FIG. 3 is flowchart of a server-side method of transmitting a plurality of related content items for display, according to an exemplary embodiment.

FIG. 4 is a flowchart of a client-side method of displaying a plurality of related content items, according to an exemplary embodiment.

FIG. 5 is a flowchart of a server-side method of transmitting a plurality of content items for display in a same window, according to an exemplary embodiment.

FIG. 6 is a flowchart of a client-side method of displaying a plurality of content items in a same window, according to an exemplary embodiment.

FIG. 7 is a flowchart of a server-side method of transmitting a plurality of content items and associated user input devices for display, according to an exemplary embodiment.

FIG. 8 is a flowchart of a client-side method of displaying a plurality of content items and associated user input devices for display, according to an exemplary embodiment.

FIGS. 9-14 are screen shots generated by the systems and methods described herein, according to exemplary embodiments.

### DETAILED DESCRIPTION OF THE ILLUSTRATIVE EMBODIMENTS

Some embodiments described herein may increase the number of web pages viewed per browsing session.

Some embodiments described herein may provide a playlist of content for a user to view within a single web browser window.

Some embodiments described herein may load additional content to a user's playlist of content based on tags, popularity, user profile, and/or other search criteria.

Some embodiments described herein may help streamline the process of finding additional relevant content on a web site for a user.

Some embodiments described herein help the user see the presence of additional content items using a table of contents on the first visible portion of the window. The table of contents may remain visible in the window as the user scrolls down the content.

Some embodiments described herein provide a convenient “read next” pop-up link next to a hyperlinked portion of an article to allow a user to load a new article and append it to the bottom of the existing article or set of articles.

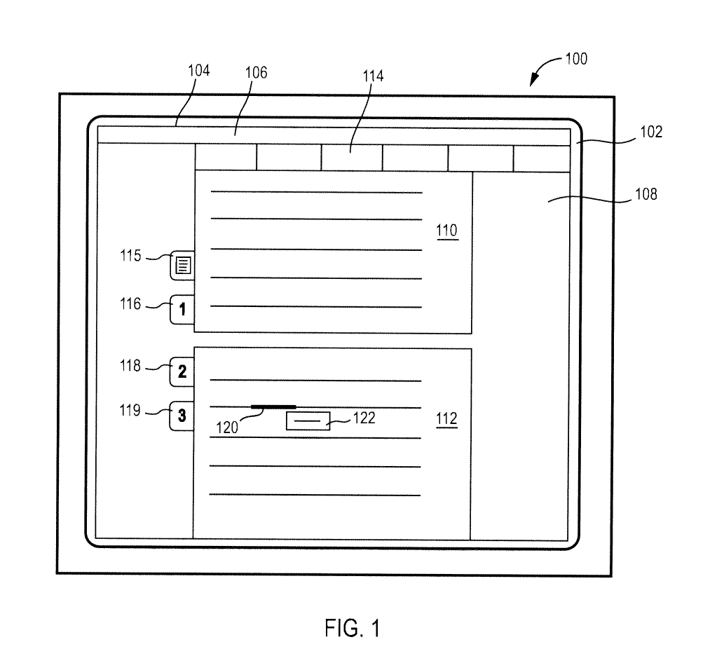

Referring first to FIG. 1, a schematic diagram of a display of related content items is shown, according to an exemplary embodiment. FIG. 1 illustrates a display device 100 comprising a screen 102. Screen 102 provides a web browser display 104 generated by a web browser application running on a client device. Web browser display 104 comprises a control or button bar 106 having user input elements associated with the web browser application. Web browser display 104 further comprises a window 108 displaying a web page comprising a first content item 110 and a second content item 112, which may be loaded from different resource locations or from the same resource location. Window 108 may further display topic buttons 114 configured to load additional web pages. User input elements 116 and 118 are each associated with first content item 110 and second content item 112, respectively. User input element 115 is a table of contents input element, and user input element 119 is associated with a third content item (not shown) loaded into window 108 but not visible until a user scrolls down window 108 to beyond the bottom of second content item 118. First content item 110 comprises a text portion 120 having an associated user input element 122 which may be selected by a user to append a fourth content item beneath the third input element, the fourth content item retrievable from a resource location associated with text portion 120.

As illustrated in FIG. 1, a user is provided with a playlist of content. As will be described in greater detail herein, additional content may be loaded based on tags from content already in the playlist, popularity, user profile data, etc, using local storage on the client device to remember the user's viewing history and their content preferences. The display further provides a table of contents that can be used as a means of navigation. The table of contents (comprising input elements 115, 116, 118 and 119) can be selectable using a mouse or using keyboard shortcuts

After a user lands on the web page comprising the first content item, the system may be configured to take tags stored with the first content item to run a query and find one or more pieces of content that are related to the first content item, based on popularity of the content items, based on user preference data from a user profile, etc. The system may be configured to load the found content into the page or window automatically (i.e. without requiring a specific user request such as a click) and/or in response to a specific user request. In one example, when the user scrolls to the bottom of the first content item or another content item in the playlist (e.g., the last content item in the playlist), the system may be configured to search for, find, and load additional content items into the same window or page. The system may also be configured to mark, store, or record the user's viewing history, so that content pieces already read are not re-loaded and/or so that the system can determine user interests (e.g., based on the user spending a predetermined time on a piece of content) and use the interests to load additional related content. The window or page continues to build on itself by finding additional content for the user.

In one embodiment, as soon as a user arrives at a page, the system retrieves x more articles.

Some content items comprise an internal link such as text portion 120. In some cases, the reader does not want to jump to the content item tied to the link until they are finished reading the first content item. In that case, the user can select input element 122 for a “next” or “follow” function which puts the linked content item at the end of the playlist or queue, or alternatively at the end of the content item containing the link.

As shown, the system can provide a continuous content playlist of individual content pieces with a navigable table of contents, while requiring little commitment on the part of the user. The content piece being viewed can be built on by running real-time searches on tags that are selected for viewing, and the results can be used to search and locate additional content items. The additional content items can be displayed in the playlist of content to keep the attention of the user. In one embodiment, upon reaching a single article additional relevant pages may be immediately or promptly loaded in beneath the current article. As the user moves down the page and nears the end of the loaded articles in the playlist, more articles may continue to get loaded. This can be continued in a pseudo-infinite playlist. The relevancy of additional content may be based on the user's first content item/destination page, and then may be fine-tuned based upon user interaction with the loaded content. Each additional request for more pages could be potentially more relevant than the last.

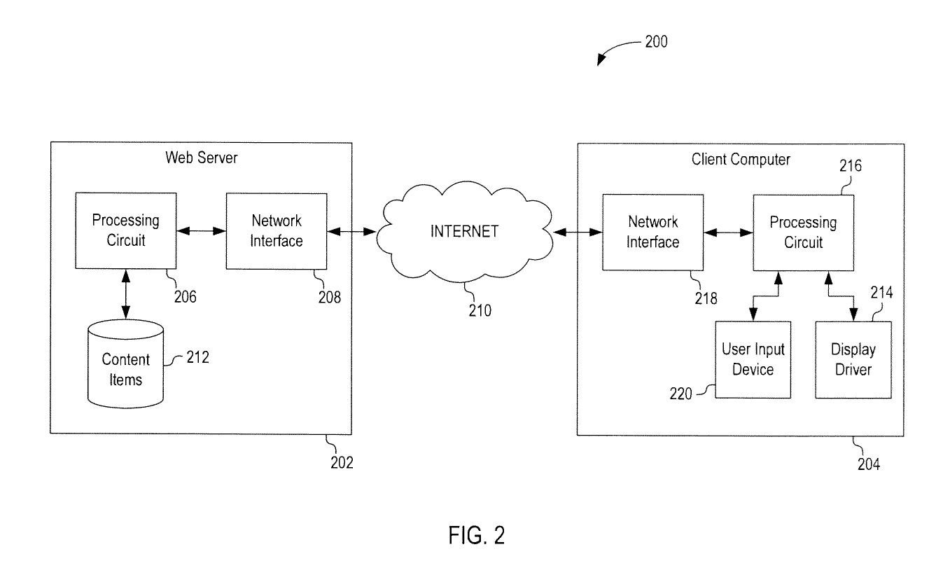

FIG. 2 is a block diagram of a computer system configured to implement the functions described herein, according to an exemplary embodiment. The computer system 200 comprises a server computer 202 and a client computer 204. Server computer 202 represents one or more server computers configured or programmed to perform the functions discussed herein. A processing circuit 206 comprises analog and/or digital circuit components configured to perform the functions discussed herein, such as one or more microprocessors, application specific integrated circuits (ASICs), programmable logic, volatile and/or non-volatile memories (e.g., cache, random access memory, read only memories, magnetic drives, optical drives, etc.), communication circuits, etc. Processing circuit 206 can comprise one or more modules, units, programmed portions, etc. Processing circuit 206 is coupled to a network interface device 208 comprising mechanical and/or electrical components configured to provide communication between processing circuit 206 and a network, such as internet 210. Other networks, such as other wide area networks (WANs), local area networks (LANs), personal area networks (PANs), and/or other networks may be provided.

Server computer 202 further comprises one or more content item databases 212 reachable by resource locators (e.g., a uniform resource locator or URL) to retrieve individual content items. The content items may comprise textual content items (e.g., an article, blog, etc.), video content items, audio content items, and/or other content items.

Client computer 204 may comprise any type of computing device, such as a personal computer, laptop computer, table computer, smartphone or other mobile telephone, network terminal, web PC, or other computing device. Client computer 204 is configured to communicate with web server computer 202 to access content items and provide them for display to a user using a display driver 214. Client computer 204 has a processing circuit 216 coupled to a network interface 218, which may comprise components such as those described above with reference to corresponding elements of web server computer 202, though programmed in other manners as described herein. Client computer 204 may further comprise a user input device 220, such as a keyboard, touch pad, mouse, roller ball, touch screen, multi-touch touch screen, speech recognition engine, and/or other input devices.

While the functions described herein will be described with reference to one manner of distributing the functions between server computer 202 and client computer 204, one or more of the functions, steps, modules, or aspects may be performed on either server computer 202 or client computer 204 in various alternative embodiments.

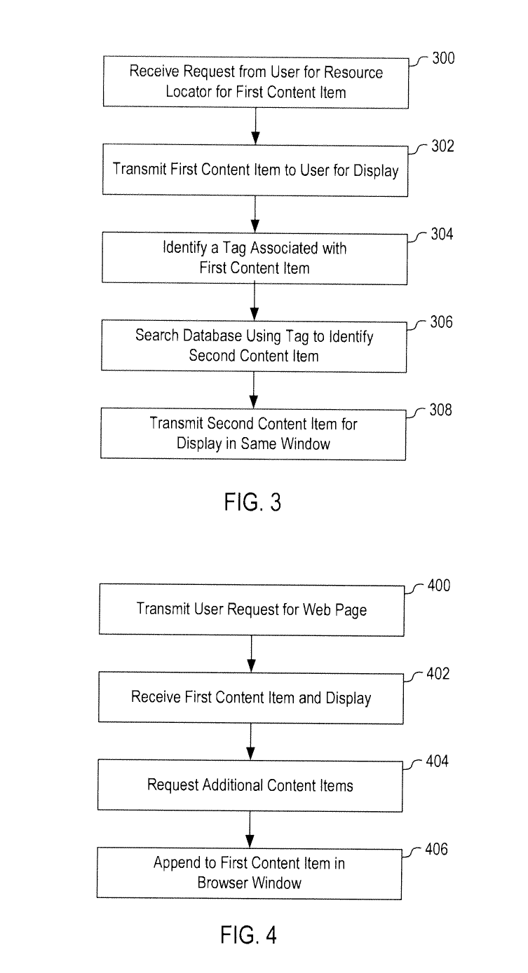

FIG. 3 is flowchart of a server-side method of transmitting a plurality of related content items for display, according to an exemplary embodiment. As described above, each content item in content items database 212 comprises tags or keywords associated therewith that relate to the content item. Tags may be inserted manually by an author or published of the content item, or derived automatically from the content of the item. At block 300, server computer 202 is configured to receive a request from a user for a resource locator associated with a first content item. At block 302, server computer 202 is configured to transmit the first content item to the user for display in a window containing the first content item. The first content item may be transmitted as hypertext machine language (HTML) in the form of a web page viewable in a web browser operating on client computer 204.

At block 304, server computer 202 is configured to identify at least one tag associated with the first content item. The tag or tags may be received from an application operating on client computer 204 or may be retrieved from the content item file by server computer 202. At block 306, server computer 202 is configured to search content item database 212 using the at least one tag to identify at least one second content item. At block 208, server computer is configured to transmit the second content item to the user for display within the same window as the first content item. The second content item (or items) may be configured to appear below the first content item when a user scrolls down in the window. In one embodiment, the second content item (or items) may be configured to appears below the first content item without substantial content therebetween, such as other articles, an advertisement, hyperlinks, etc.

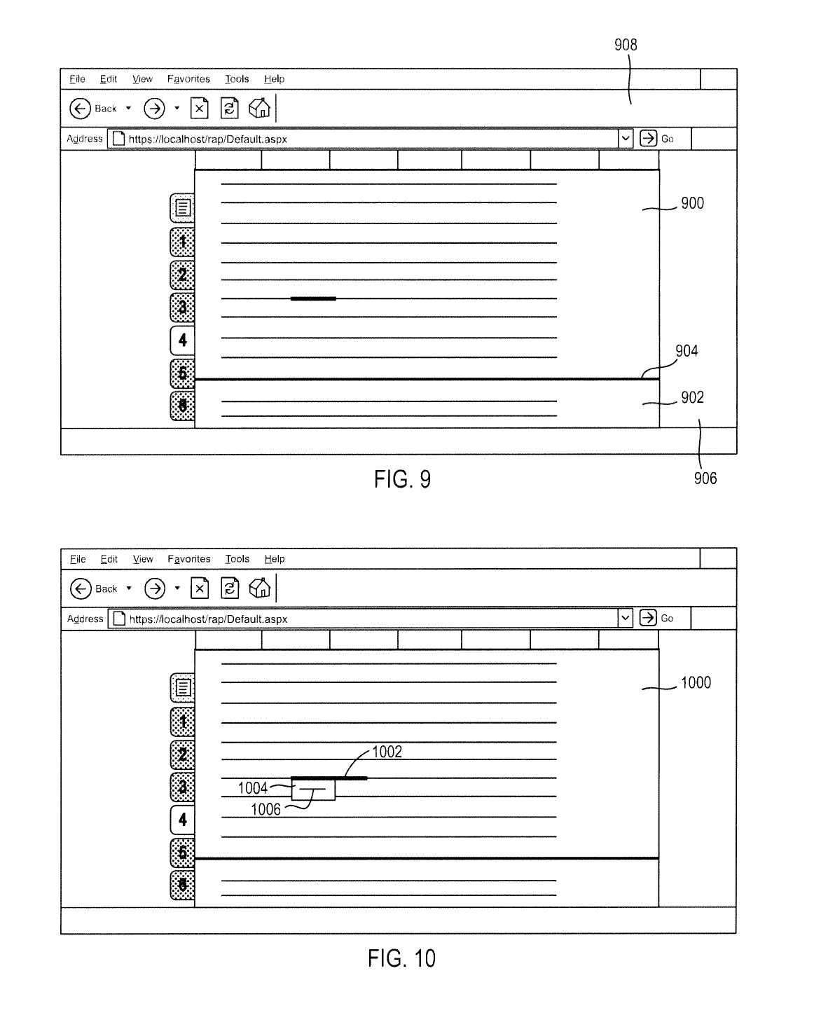

FIG. 9 illustrates an exemplary screen shot illustrating a first content item 900 and a second content item 902, without substantial content therebetween at a portion 904 of the image being displayed. Content items 900 and 902 are displayed within a same window or page 906, one beneath or below the other, within a web browser application 908.

The second content item may be retrieved from a URL which is different than the URL of the first content item, yet displayed within a same window or page of the web browser.

According to another exemplary embodiment, server computer 202 may be configured to select the one or more second content items based further on user preferences of the user viewing the first content item, who transmitted the request for the first content item. For example, server computer 202 may be configured to receive a user identifier from the user, such as user login credentials (e.g., username, password, etc.), and/or from a browser cookie associated with the user's browser. Server computer 202 may be configured to retrieve a user profile for the user from a user profile data store and select the second content item or items based further on data from the user profile. For example, user data may be retrieved from a user profile database such as that described in U.S. patent application Ser. No. 13/023,377 filed Feb. 8, 2011 entitled “Targeting Offers to Users of A Website,” which is incorporated by reference herein in its entirety. As another example, user data may be retrieved from a user data store such as that described in U.S. patent application Ser. No. 13/093,658 filed Apr. 25, 2011 entitled “User Data Store,” which is incorporated by reference herein in its entirety.

The additional content items may be based on data other than tags of the first content piece. The search algorithm may use content a person likes, for example by receiving an active user selection of a “like” or “+1” button near content, by receiving an indication from the user that a user likes a particular author, by storing an interest of the user and finding a category of blog related to the interest of the user, by using information about the site that referred the user to the first content (e.g., tags associated with the site if a content side or publisher), etc. The search algorithm may select content based on a user's location (e.g., obtained from IP address), or from other information.

The retrieval and transmission of second content items related to the first content item, user profile, browsing history, etc. can happen in a variety of ways. In one example, when a user arrives at the web page having the first content item, a plurality of additional content items are automatically retrieved and loaded into the content playlist without requiring any further user input. In another example, the additional content items are not retrieved and/or loaded until the user reaches the end of the first content item by scrolling to the end in the web browser window. In another example, the additional content items are not retrieved and/or loaded until the user begins scrolling down within the browser window, though the end of the article may not have yet been reached. In another example, a user may click on a tab of a table of contents to request additional content, or on another link stating “more articles like this” to retrieve additional content. In any of the above examples, any number of additional content items may be retrieved, such as one, at least two, at least three, etc.

According to some embodiments, the content items may comprise unabridged textual documents, textual documents which are not merely summaries of the full document. In other embodiments, abridged versions of the documents may be loaded.

In one embodiment, the system may be configured to track where a person is reading in a content item. A tracking module may be configured to determine which pieces of content the user has read. The tracking module tracks how long a piece of content has been visible in the window, and makes an inference of having been read based upon the time. This tracking information may be used to prevent showing the same content piece to the user again, as well as factor it into the user's viewing preferences.

FIG. 4 is a flowchart of a client-side method of displaying a plurality of related content items, according to an exemplary embodiment. At block 400, client computer 204 receives a user request for a web page, for example by receiving a URL from the user or by the user clicking on a link on another page, such as a search engine web page. Client computer 204 transmits the user request for the web page to server computer 202. Client computer 204 then receives the requested content item (block 402) and displays it within a web browser application operating on client computer 204. At block 404, client computer 204 requests additional content items 404 and at block 406 appends the additional content items received from server computer 202 to the first content item in the same browser window or page.

Client computer 204 may be configured to load the content items and store them in a local memory, including content identifiers of the content already reviewed by the user or otherwise displayed in the browser window. In one embodiment, a JavaScript module is received from server computer 202 at client computer 204 which interacts with the local storage. The JavaScript module may operate in a manner akin to a cookie, but with capacity to store much more data. The JavaScript module may be formatted in accordance with a HTML standard, such as HTML5. The JavaScript module may be configured to make an asynchronous request, passing data such as which content IDs have already been viewed by a user, which may further comprise the tags of one or more content items in the content playlist, such as the first content item. Server computer 202, upon receiving the data, may execute a PHP file to build the HTML of what is to be viewed from the article. The PHP file may further be configured to generate table of contents information, as will be described in greater detail below. The JavaScript module operating on client computer 204 may be configured to inject the formatted html from the PHP file into the correct location on the web page displayed by the browser. As the user scrolls, this process may be repeated to append additional content.

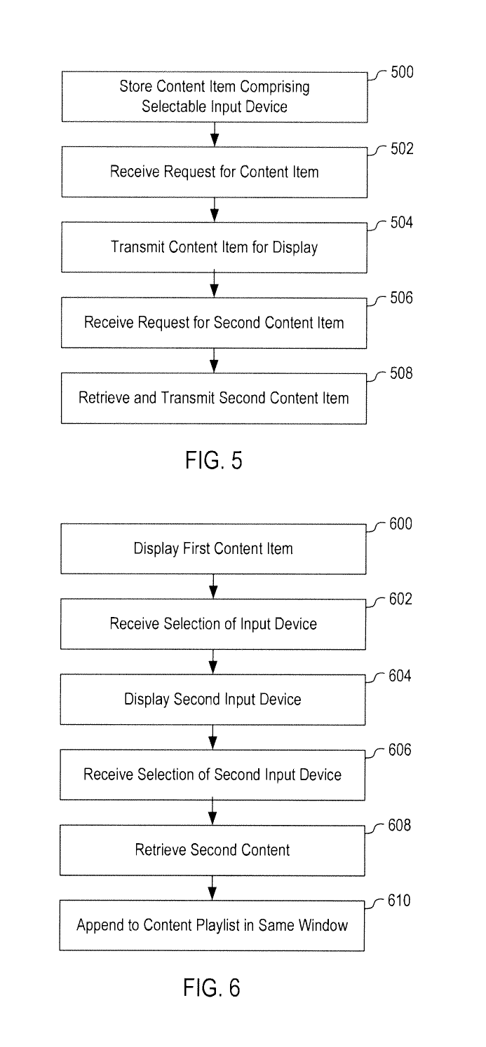

Referring now to FIG. 5, a flowchart of a server-side method of providing a “read next” or “follow” feature will be described. At block 500, a memory is configured to store a plurality of content items, a first content item containing a selectable input device to direct a user to a second content item, such as a URL. At block 502, the server computer is configured to receive a request from a user for a resource locator associated with the first content item. At block 504, the server computer is configured to transmit the first content item to the user for display in a window containing the first content item. At block 506, the server computer is configured to receive from the user a request for the second content item. The request is in response to a user selection of the selectable input device within the first content item being displayed in the web browser. Upon selection of the selectable input device (e.g., a hyperlink), a second selectable input device is displayed at the client browser window. Upon selection of the second selectable input device (e.g., a pop-up asking if the user would like to “read next” or “append” an article to the article being read), server receives the request for the second content item. At block 508, the server computer is configured to retrieve the second content item and transmit the second content item to the user. The second content item is displayed beneath the first content item, or elsewhere in the same browser window or page.

In one embodiment, the second content item is retrieved from server-side memory and transmitted to the user in response to selection of the second selectable input device.

In another embodiment, the “Read Next” option may be displayed upon mouse over of the link, e.g.,. by moving a cursor over the selection device without yet having clicked on the selection device.

Referring to FIG. 10, an exemplary screen shot of a “read next” feature is shown. A first content item 1000 comprises a selectable input device 1002, which is a link to direct a user to another content piece relating to the text that is highlighted. Upon user selection of the device 1002, a display portion, such as a pop-up display 1004 is loaded from local memory or form the server computer to provide a second user input device 1006, which in this case is a hyperlink associated with the words “read next.” Upon selection of device 1006, a request is made to retrieve the second content (either from local memory if previously loaded or from the server computer if not previously loaded or cached) and the second content is formatted by server and/or client to appear at the end of the content playlist, or beneath or below the content item 1000.

FIG. 6 is a flowchart of a client-side method of providing a “read next” or “follow” feature. At block 600, the client computer is configured to display the first content item. At block 602, the client computer may receive a selection of the selectable input device within the first content item. At block 604, a second input device is displayed along with text prompting to user whether the user would like to load the content into the playlist (which may include a second input device for “read now” which will then provide a new browser window with the content, and a third input device for “read now in playlist” which will load into the playlist and jump to that portion of the playlist within the same browser window). At block 606, the client computer receives the user's selection of the second (or third, fourth, etc.) input device. The new content is then retrieved, either from local storage if cached or from the server computer (block 608) and appended to the content playlist in the same window or page as the first content item (block 610).

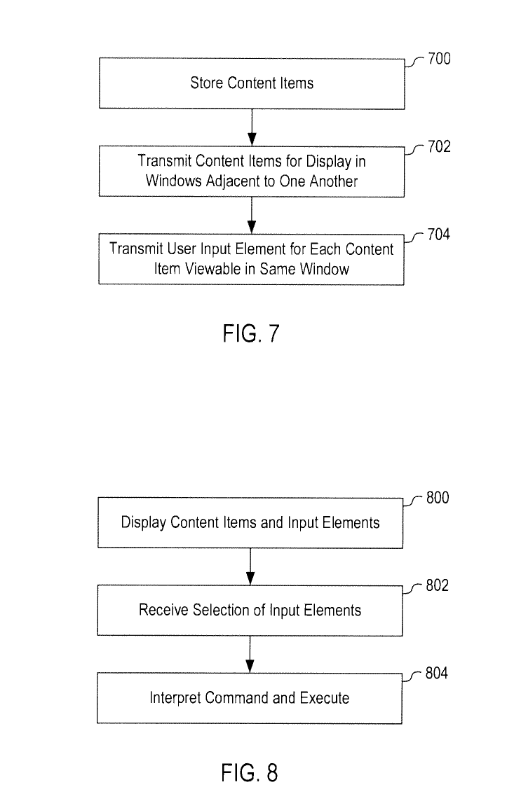

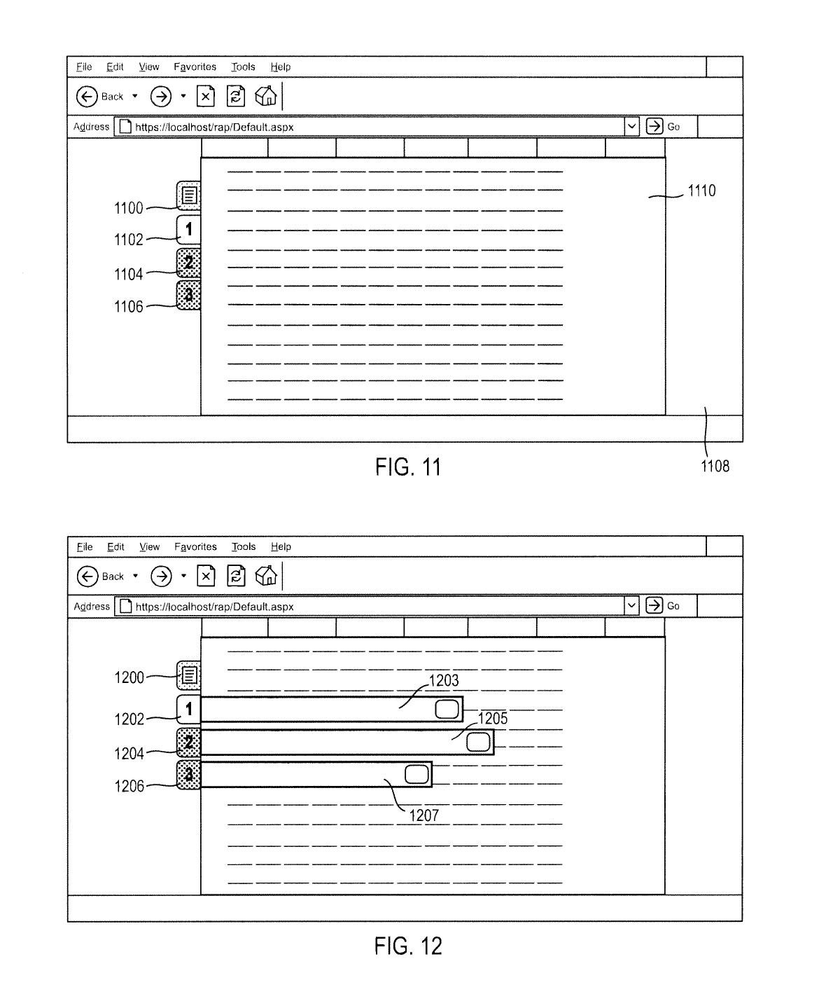

Referring now to FIG. 7, a flowchart of a server-side method of transmitting a plurality of content items and associated user input devices for display with be described, according to an exemplary embodiment. The associated user input device may form part of a table of contents having selectable links for navigating through the display. FIG. 11 shows an exemplary screen shot of a display on a client computer of the user input devices 1100, 1102, 1104 and 1106.

At block 700, the server computer has stored a plurality of content items. At block 702, the server computer is configured to transmit a plurality of the content items to a client device for display in a window, one adjacent the other. The items can be displayed in the form of a content playlist, one after another, or left to right, or in other configurations. In some embodiments, a small amount of additional content, such as links, advertisements, etc. may be displayed between adjacent items. In other embodiments, the items are displayed adjacent each other without substantial additional content therebetween. At block 704, the server computer is configured to transmit to the client device a user input element for each content item. The user input elements may be viewable on a same portion of the window and selectable to display a respective content item in the same portion of the window. For example, in FIG. 11, a visible portion of window 1108 shows a portion of a first content item 1110 and also a plurality of input device 1100-1106 for a plurality of content items including the first content item. The user input elements are disposed outside the content items in the window. In this embodiment, the user input elements are disposed leftward of the displayed content item.

The user input elements may take a variety of forms and shapes, such as circular, square, tab-shaped, all the same size, some larger than others, attached to or disconnected from a content display portion of the page or window, etc. In this embodiment, the user input elements comprise tabs 1100-1106 extending from the displayed content item 1110.

The table of contents user interface made up of tabs 1100-1106 may be automatically generated to aide with article navigation and selection, as well as user comprehension as to what is taking place. For example, by simply displaying additional tabs, the user is informed that additional content has been loaded into the playlist. The table of contents user interface could be used with the content playlist feature described herein or with other site pages such as a blog post listing (door), topic pages, or any package of articles. For example, a plurality of topic pages may be collected or a plurality of search results may be collected, and the user can load these results as full pages and give the user the ability to quickly move through them with the table of contents.

Selection of the user input elements 1100-1106 may trigger a wide variety of different functions in various embodiments. In one embodiment, illustrated in the screen shot of FIG. 12, upon selection of input device 1200, a toggle of article metadata may be provided in a field 1203, 1205, 1207 that extends from each user input element 1202, 1204 and 1206. The metadata can comprise any metadata about the content item, such as a title, author, length, number of “Likes”, number of readers or views, current or life-to-date (indicating popularity), the count of total comments provided about the article from users, or other metadata. The fields 1203, 1205 and 1207 may extend the user input element of the corresponding tabs 1202, 1204, 1206, or additional, discrete user input elements may be provided in the extended fields. The fields may provide additional data which is not necessarily metadata, such as social network buttons configured to share the link to a variety of social network websites.

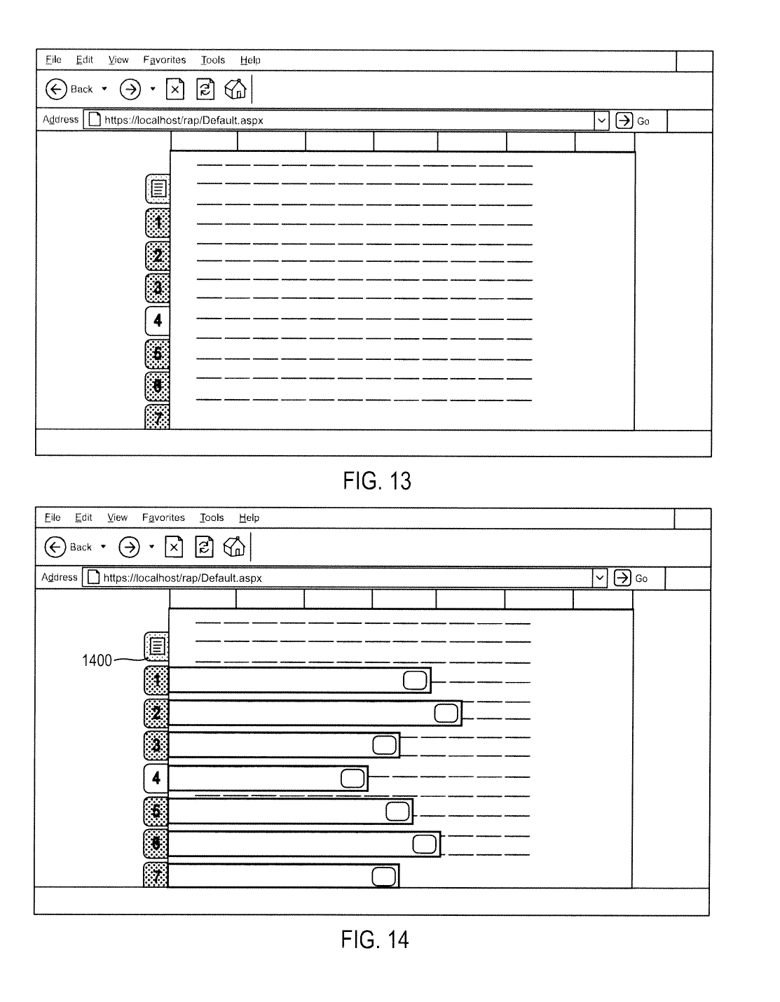

In response to selection of user input element 1204, the client computer may be configured to scroll the user down to the beginning of the second content item. In response to selection of user input element 1206, the client computer may be configured to scroll the user down to the beginning of the third content item and/or load additional content items, such as items 4, 5, 6 and 7 as shown in FIG. 13. The user input element corresponding to the content item currently being shown in the visible portion of the window may be shown with a different appearance, such as a highlighting, color change, 3-D-like pop-out, or other appearance. As shown in FIG. 14, selecting the table of contents icon or tab 1400 then displays the metadata fields for the previously loaded items in the playlist and the newly loaded items in the playlist. The extended fields may overlay a portion of the content item also displayed, as shown.

The playlisting interface and/or table of contents may be controlled with keyboard commands instead of or in addition to user clicks. For example, left and right arrows may scroll through the articles. As another example, the playlist descriptive view may be toggled (opened and closed) using a particular key on a keyboard.

FIG. 8 is a flowchart of a client-side method of displaying a plurality of content items and associated user input devices for display, according to an exemplary embodiment. At block 800, content items and input elements associated with the content items are displayed on a window of a web browser. At block 802, a selection of one of the input elements is received. At block 804, the user selection is interpreted and executed.

According to one embodiment, the input elements “travel” with the window as a user scrolls down the window from one article to the next. The input elements are in this way always present so that a user may use them to jump to any of the articles loaded.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein.

The above-described embodiments can be implemented using hardware, software or a combination thereof. When implemented in software, the software code can be executed on any suitable processor or collection of processors, whether provided in a single computer system (“computer”) or distributed among multiple computers.

Further, it should be appreciated that a computer may be embodied in any of a number of forms, such as a rack-mounted computer, a desktop computer, a laptop computer, or a tablet computer. Additionally, a computer may be embedded in a device not generally regarded as a computer but with suitable processing capabilities, including a Personal Digital Assistant (PDA), a smart phone or any other suitable portable or fixed electronic device.

The various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, various inventive concepts may be embodied as a computer readable storage medium (or multiple computer readable storage media) (e.g., a computer memory, one or more floppy discs, compact discs, optical discs, magnetic tapes, flash memories, circuit configurations in Field Programmable Gate Arrays or other semiconductor devices, or other non-transitory medium or tangible computer storage medium) encoded with one or more programs that, when executed on one or more computers or other processors, perform methods that implement the various embodiments of the invention discussed above. The computer readable medium or media can be transportable, such that the program or programs stored thereon can be loaded onto one or more different computers or other processors to implement various aspects of the present invention as discussed above.

Additionally, it should be appreciated that according to one aspect, one or more computer programs that when executed perform methods of the present invention need not reside on a single computer or processor, but may be distributed in a modular fashion amongst a number of different computers or processors to implement various aspects of the present invention.

The indefinite articles “a” and “an,” as used herein in the specification and in the claims, unless clearly indicated to the contrary, should be understood to mean “at least one.”

1. A web server computer, comprising:
a memory configured to store a plurality of articles, each article having tags representing the subject matter of the articles;
a processing circuit configured to:
receive a request from a user for a resource locator associated with a first article;
transmit the first article to the user for display in a window containing the first article;
identify at least one tag associated with the first article;
search the database using the at least one tag to identify a second article; and
transmit the second article to the user for display within the same window as the first article.

2. The web server computer of claim 1, wherein the processing circuit is further configured to:
wherein the second article appears below the first article when a user scrolls down in the window.

3. The web server computer of claim 2, wherein the second article appears below the first article without substantial content therebetween.

4. The web server computer of claim 1, wherein the processing circuit further is configured to:
retrieve the second article from a second resource locator different than the resource locator.

5. The web server computer of claim 1, wherein the processing circuit is further configured to:
receive a user identifier from the user;
retrieve a user profile for the user; and
select the second article based further on data from the user profile.

6. The web server computer of claim 1, wherein the processing circuit is configured to search for and transmit the second article without requiring a user request for content.

7. The web server computer of claim 1, wherein the processing circuit is configured to search for and transmit the second article in response to a signal indicating the user has scrolled to the bottom of the first article.

8. The web server computer of claim 1, wherein the processing circuit is configured to search for and transmit a plurality of articles in response to the signal indicating the user has scrolled to the bottom of one of the first and second articles.

9. The web server computer of claim 1, wherein the first and second articles are unabridged textual documents.

10. The web server computer of claim 1, wherein the processing circuit is further configured to:
transmit to the user a user input element for each article, the user input elements viewable on a same portion of the window and selectable to display a respective article in a viewable portion of the window, the user input elements disposed outside the articles in the window.

11. The web server computer of claim 10, the first article containing a selectable input device to direct a user to the second article, the processing circuit further configured to:
receive from the user a request for the second article, the request being in response to a selection of the selectable input device within the first article, wherein a second selectable input device is displayed in response to user selection of the selectable input device, request further being in response to a selection of the second selectable input device; and
retrieve the second article.

12. A web server computer, comprising:
a memory configured to store a plurality of articles, a first article containing a selectable input device to direct a user to a second article;
a processing circuit configured to:
receive a request from a user for a resource locator associated with the first article;
transmit the first article to the user for display in a window containing the first article;
receive from the user a request for the second article, the request being in response to a selection of the selectable input device within the first article, wherein a second selectable input device is displayed in response to user selection of the selectable input device, the request further being in response to a selection of the second selectable input device;
retrieve the second article; and
transmit the second article to the user.

13. The web server computer of claim 12, wherein the second article is displayed beneath the first article.

14. The web server computer of claim 12, wherein the second article is retrieved from server-side memory and transmitted to the user in response to selection of the second selectable input device.

15. A web server computer, comprising:
a memory configured to store a plurality of content items;
a processing circuit configured to:
transmit a plurality of the content items to a client device for display in a window, one adjacent the other; and
transmit to the client device a user input element for each content item, the user input elements viewable on a same portion of the window and selectable to display a respective content item in the same portion of the window, the user input elements disposed outside the content items in the window when not selected, and the user input elements extending out over the content items in the window when selected.

16. The web server computer of claim 15, wherein the user input elements are disposed leftward of the displayed content item.

17. The web server computer of claim 16, wherein the user input elements comprise tabs extending from the displayed content item.

18. The web server computer of claim 15, wherein the plurality of content items are displayed in unabridged format.

19. The web server computer of claim 18, wherein the unabridged content items are disposed in the window one beneath the other.

20. The web server computer of claim 17, wherein, in response to user input at one of the user input elements, metadata relating to the article is displayed in a field extending from a corresponding tab.

21. The web server computer of claim 1, the processing circuit further configured to transmit a resource locator for locating the second article to the user for display within the same window as the first article in a pop-up window that overlays or is displayed next to the first article.
